(19) United States
(12) Patent Application Publication
(10) Pub. No.: US 2015/0259214 A1
(43) Pub. Date: Sep. 17, 2015

(54) METHOD FOR MANUFACTURING HYBRID IMOGOLITE NANOTUBES

(71) Applicant: COMMISSARIAT A L'ENERGIE ATOMIQUE ET AUX ENERGIES ALTERNATIVES, Paris (FR)

(72) Inventors: Béatrice Rouleau, Paray-Vieille-Poste (FR); Antoine Thill, Fontenay aux Roses (FR); Olivier Poncelet, Grenoble (FR)

(73) Assignee: Commissariat a l'Energie Atomique et aux Energies Alternatives, Paris (FR)

(21) Appl. No.: 14/646,754

(22) PCT Filed: Nov. 22, 2013
(86) PCT No.: PCT/IB2013/060337

§ 371 Date: May 22, 2015

(30) Foreign Application Priority Data
Nov. 23, 2012 (FR) 12 61194

(51) Int. Cl. C01B 33/26

(52) U.S. Cl. CPC C01B 33/26; C01P 2004/13

(57) ABSTRACT

The present invention relates to a method for manufacturing hybrid imogolite nanotubes, which includes the following steps: (i) dissolving an aluminium precursor in an aqueous solution; (vi) under agitation, adding at least one silicon alkoxide, in which the silicon has hydrolysable substituents and at least one non-hydrolysable substituent, to the aluminium solution obtained at the end of step (i), the molar ratio of Al/Si necessarily being from 1 to 4; (vii) under agitation, adding a base to the aluminosilicate solution obtained at the end of step (ii), until obtaining a hydrolysis ratio of 1 to 3; (viii) maintaining agitation for a duration of at least 15 hours; (ix) heating the solution obtained at the end of step (iv) to a temperature of 50° C. to 150° C. for a duration of 2 to 8 days. The present invention also relates to hybrid imogolite nanotubes that simultaneously include a hydrophilic surface and a hydrophobic surface, and have an outer diameter of 3.3 nm to 3.4 nm, which can be obtained via said method.

The present invention relates to a process for the manufacture of hybrid imogolite nanotubes and also to the hybrid imogolite nanotubes capable of being obtained via this process.

Imogolite, a filamentary, tubular and crystalline aluminosilicate, present in the natural state in volcanic ash and in some soils, is currently arousing great interest. This is because imogolite exhibits numerous advantages in comparison with carbon nanotubes, in particular due to its complete transparency (artificial imogolite is colorless) and its controlled processes of synthesis in a liquid medium make it possible to regulate the length of the nanotubes (reproducible process) while preventing any risk of inhalation by the handlers and final users.

Nevertheless, imogolite nanotubes remain hydrophilic inorganic materials which are incompatible with hydrophobic molecules and which are difficult to formulate in organic matrices.

Several methods have been envisaged for improving the compatibility of imogolite with nonpolar media and molecules:
processes by external functionalization, such as those described by K. Yamamoto et al., Chemistry Letters, 2001, 1162-1163; B. H. Bac et al., Inorganic Chemistry Communications, 12, 2009, 1045-1048; W. Ma et al., Chem. Commun., 2011, 47, 5813-5815,
processes by internal functionalization, such that described by I. Bottero et al., Phys. Chem. Chem. Phys., 2010, in which the SiCH₃ groups are introduced in place of the SiOH groups naturally present on the internal surface of the imogolite, or also that of D-Y. Kang et al., J. Phys. Chem., 2011, 115, 7676-7685, which describes a method for the postfunctionalization of imogolite by vacuum evaporation of organic precursors.

Nevertheless, there are several disadvantages to these complex methods: the process of I. Bottero et al., for example, requires the use both of a stage of washing by centrifuging and a stage of diluting before heating, the process of D-Y. Kang for its part requiring expensive handling of the nanotubes in the dehydrated form. In the case of fibrous nanoparticles, it is also necessary to be protected from risks of inhalation (dangerous handling).

The technical problem to be solved with respect to this state of the art consists of the development of inorganic fillers which are compatible with nonpolar media and molecules, without detrimentally affecting the transparency thereof.

Entirely surprisingly, the inventors have succeeded in developing a process for the manufacture of hybrid nanotubes based on imogolite, without compromising the transparency of the suspensions and films. The hybrid imogolite nanotubes of the invention exhibit in addition a twofold hydrophilic nature on the outside of the nanotube and a hydrophobic nature on the inside of the nanotube.

The process developed by the inventors also exhibits the advantage of not requiring any stage of centrifuging, diluting, drying or placing under vacuum. The process is thus very simple to carry out, and economically more advantageous and less dangerous for the final handlers than the processes of the prior art.

The process of the invention makes it possible to obtain hybrid imogolite nanotubes, the internal surface of which may be entirely functionalized, said nanotubes being obtained in a large amount and with an excellent yield.

Thus, the invention relates to a process for the manufacture of hybrid imogolite nanotubes comprising the following stages:

(i) dissolution of a precursor of the aluminum in an aqueous solution, it being possible for said dissolution stage to be carried out with stirring and preferably in a Teflon or glass container,

(ii) with stirring, addition to the aluminum solution obtained during stage (i) of at least one silicon alkoxide, the silicon of which carries both hydrolyzable substituents and at least one nonhydrolyzable substituent, the Al/Si molar ratio having to be between 1 and 4, preferably between 1.5 and 2.5 and more preferably still equal to 2,

(iii) with stirring, addition of a base to the aluminosilicate solution obtained during stage (ii), until a hydrolysis ratio (base/aluminum molar ratio) of between 1 and 3, preferably between 1.5 and 2.5 and more preferably still equal to 2 is obtained,

(iv) maintenance of the stirring for a period of time of at least 15 hours and preferably of at least 20 hours,

(v) heating the solution obtained during stage (iv) at a temperature of between 50 and 150° C., for a period of time of between 2 and 8 days.

Within the meaning understood by the invention, the expression “nonhydrolyzable substituent” denotes a substituent which does not separate off from the silicon atom during the process and in particular during the basic hydrolysis. In contrast, the expression “hydrolyzable substituent” denotes a substituent which is removed during the basic hydrolysis.

According to an advantageous embodiment, the precursor of the aluminum employed during stage (i) is chosen from aluminum perchlorate Al(ClO₄)₃, aluminum nitrate Al(NO₃)₃ or aluminum chloride AlCl₃, the aluminum perchlorate Al(ClO₄)₃ being the preferred precursor.

The aluminum concentration of the aqueous solution obtained during stage (i) can be between 0.01 and 1 mol.l⁻¹ and preferably between 0.05 and 0.1 mol.l⁻¹.

Advantageously, the silicon alkoxide or the mixture of silicon alkoxides added during stage (ii) correspond to the formula X—Si(OR)₃, in which R is a linear or branched C₁-C₆ alkyl or alkenyl group or a phenyl group, it being possible for said R group to optionally carry a substituent chosen from —OH, —NH₂, —COOH, a phenyl group or a halogen atom, and X is a linear or branched C₁-C₁₂ alkyl group. Preferably, R represents a methyl, ethyl, propyl, butyl or vinyl group and more preferably still R is a methyl or ethyl group. Preferably, X is a methyl, ethyl or propyl group and more preferably still X is a methyl group. The preferred silicon alkoxides are methyltriethoxysilane (OC₂H₅)₃SiCH₃, methyltrimethoxysilane (OCH₃)₃SiCH₃ and phenyltriethoxysilane (OC₂H₅)₃SiC₆H₅.

The hydrolysis ratio is a synthesis parameter well known to a person skilled in the art which can be determined throughout the reaction from the pH. It corresponds to the base/aluminum molar ratio (ratio of the concentration of base added to the amount of aluminum initially present).

The base added during stage (iii) can be chosen from sodium hydroxide, potassium hydroxide or lithium hydroxide and said base is preferably sodium hydroxide. Its concentration can be between 0.1 and 3 mol.L⁻¹. During stage (iii), the addition of the base is advantageously carried out at a flow rate of between 1 and 10 mL.min⁻¹ and preferably between 3 and 5 mL.min⁻¹.

The heating of stage (v) can be carried out at a temperature of between 70 and 150° C. and preferably between 80 and 90° C., either in an autoclave or in an oven or at reflux.

According to an advantageous embodiment, the duration of the heating stage (v) is between 4 and 6 days.

The process of the invention can additionally comprise a stage (vi) of washing or concentrating the solution obtained during stage (v). The washing stage serves to remove, from the reaction medium, the byproducts formed during stages (i) to (iii), such as the residual ions originating from the base used during stage (iii) or the alcohols originating from the hydrolysis of the alkoxide. Stage (vi) can thus be carried out either by washing by successive sedimentations or by dialysis, on the one hand, or by concentration by ultrafiltration, on the other hand.

A subsequent lyophilization stage (vii) may also be carried out in order to obtain the hybrid imogolite nanotubes synthesized in the solid form.

Another subject matter of the invention is the hybrid imogolite nanotubes as such capable of being obtained according to the process of the invention and simultaneously comprising a hydrophilic surface or hydrophobic surface.

The hybrid imogolite nanotubes of the invention exhibit an external diameter ranging from 3.1 to 3.6 nm and preferably from 3.3 to 3.4 nm, measured by small angle X-ray scattering (SAXS), this diameter being much larger than those obtained via the processes described in I. Bottero et al., Phys. Chem. Chem. Phys., 2010 (diameter d=2.99-3.02 nm) and D-Y. Kang et al., J. Phys. Chem., 2011, 115, 7676-7685 (diameter d=2.2-2.8 nm).

Cryogenic transmission electron microscopy (Cryo-TEM) measurements have also made it possible to determine a length of hybrid imogolite nanotubes of the invention of between 100 and 200 nm (limits included).

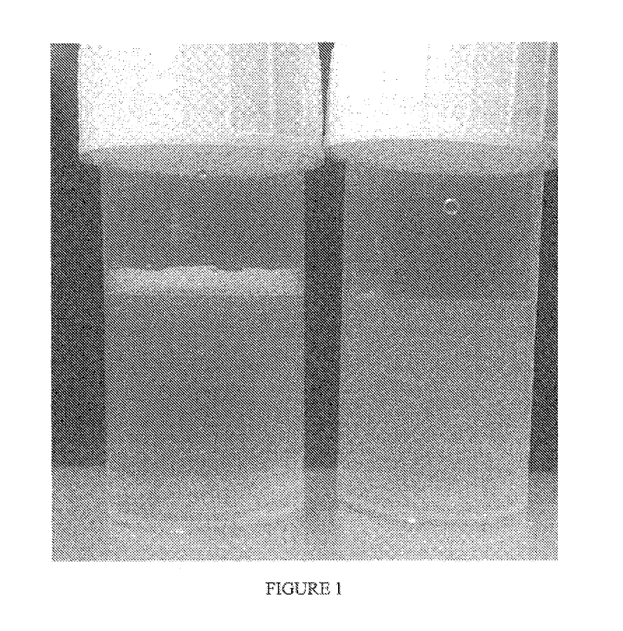

The inventors have observed that the hybrid imogolite nanotubes obtained according to the process of the invention, in contrast to the hybrid imogolite nanotubes obtained according to the method described by I. Bottero et al., Phys. Chem. Chem. Phys., 2010, form a foam when they are dispersed in solution (FIG. 1). The formation of this foam reflects a better adsorption of the nanotubes of the invention at the water/air interface and consequently a better surfactant power than those obtained according to the method of I. Bottero et al., Phys. Chem. Chem. Phys., 2010.

In addition to the preceding provisions, the invention also comprises other provisions which will emerge from the remainder of the description which follows, which relates to examples of the synthesis of hybrid imogolite nanotubes, and also from the appended figures, in which:

FIG. 1 compares a dispersion of hybrid imogolite nanotubes which are obtained according to the process of the invention with a dispersion of hybrid imogolite nanotubes which are obtained according to the method of I. Bottero et al., Phys. Chem. Chem. Phys., 2010,

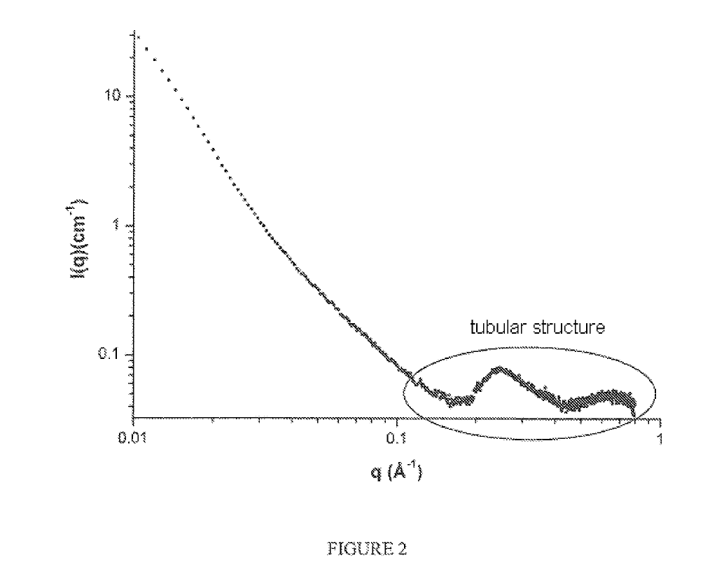

FIG. 2 represents a small angle X-ray scattering (SAXS) curve of hybrid imogolite nanotubes synthesized according to example 1,

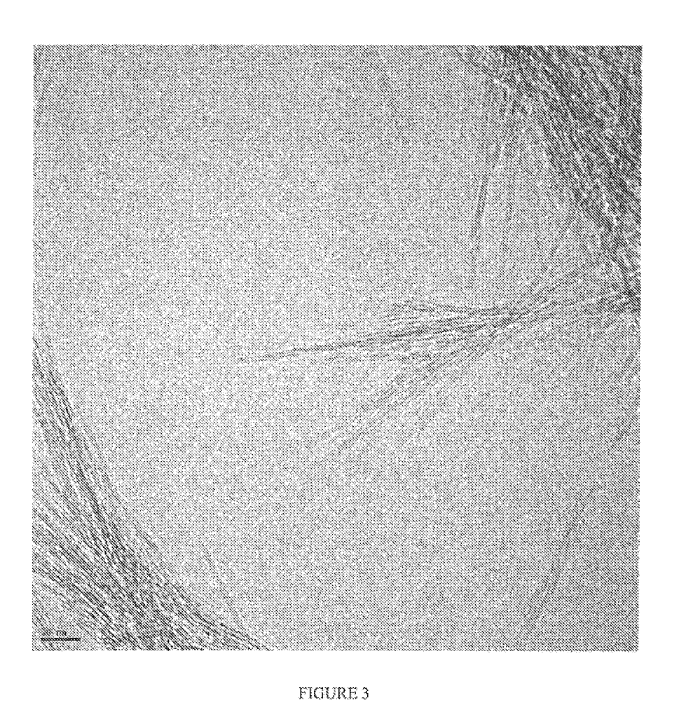

FIG. 3 is a cryo-TEM image of the hybrid imogolite nanotubes synthesized according to example 1,

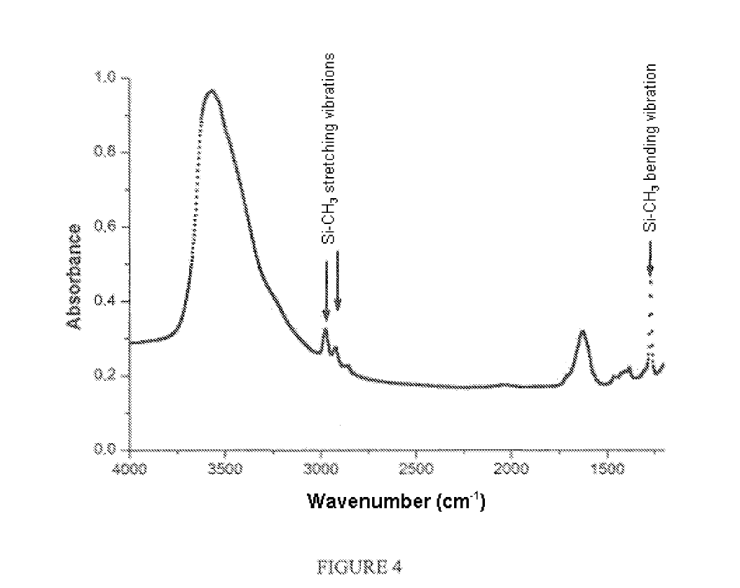

FIG. 4 is an infrared spectrum of a hybrid imogolite nanotube synthesized according to example 1,

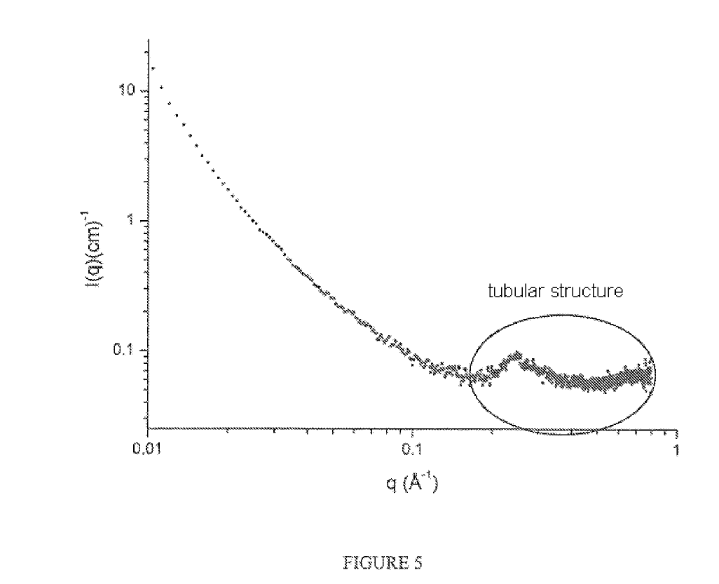

FIG. 5 represents a small angle X-ray scattering (SAXS) curve of hybrid imogolite nanotubes synthesized according to example 2,

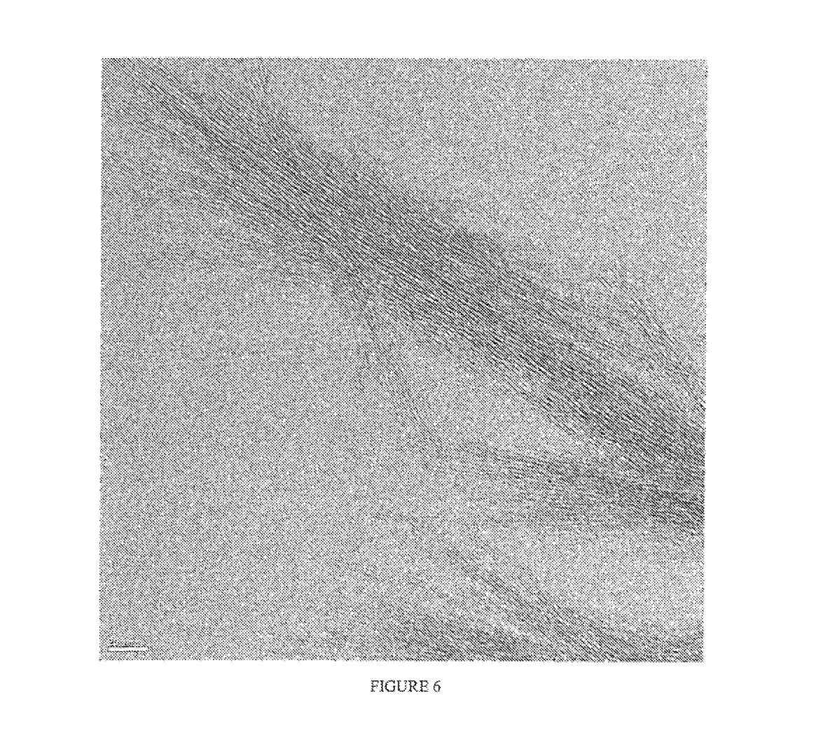

FIG. 6 is a cryo-TEM image of the hybrid imogolite nanotubes synthesized according to example 2,

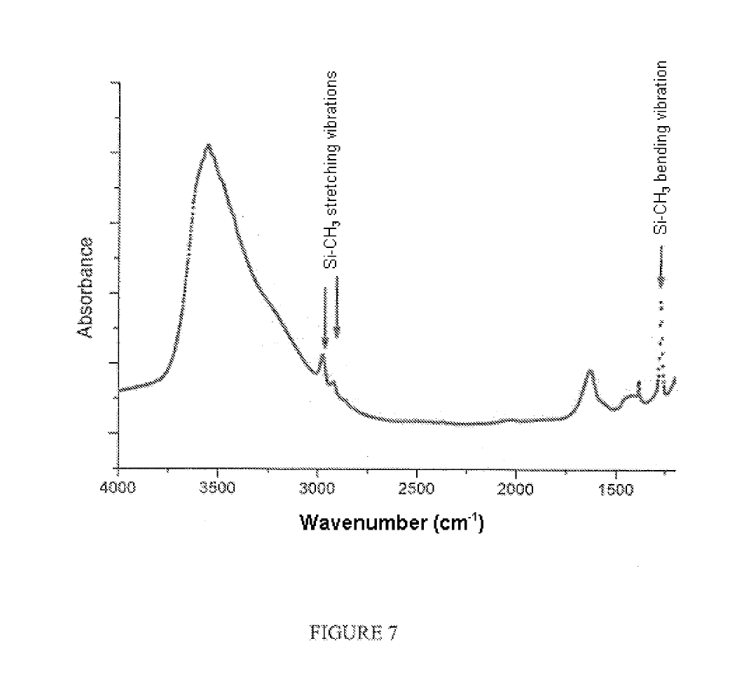

FIG. 7 is an infrared spectrum of a hybrid imogolite nanotube synthesized according to example 2.

### EXPERIMENTAL PART

### Example 1

30 mL of a solution of aluminosilicate, the aluminum/silicon molar ratio of which is set at 2 and the hydrolysis ratio (sodium hydroxide/aluminum molar ratio) of which is also set at 2, were prepared as follows:
an aqueous aluminum solution is prepared by dissolving 0.487 g of aluminum perchlorate in pure water, in order to obtain a 0.1 mol.l⁻¹ solution, and is then transferred into a 10 mL volumetric flask,
a solution of 50 mL of 0.1 moL.l⁻¹ sodium hydroxide is prepared by dissolving 0.2 g of sodium hydroxide and is then transferred into a 20 mL volumetric flask.

The aluminum perchlorate solution is transferred into a Teflon container containing a magnetic bar and is then stirred. Methyltriethoxysilane (99.6 μL) is added to the solution. The sodium hydroxide solution is subsequently added at a flow rate of 4 mL.min⁻¹ using a peristaltic pump. Once the addition is complete, the Teflon container is closed and left stirring at ambient temperature for a period of time of 20 h, and then placed in an oven at 85° C. for 5 days. The solution is subsequently washed and filtered several times in pure water using a 30 kDa membrane.

In order to be able to analyze the hybrid imogolite nanotubes thus prepared, the latter were lyophilized in the solid form. A white powder, of very low density and volatile, is obtained.

The yield of this synthesis is at least 50%.

The tubular structure of hybrid imogolite nanotubes was demonstrated by SAXS (Small-Angle X-ray Scattering), cryo-TEM on a Tecnai G² Polara device and IR (infrared) spectroscopy on a Bruker Vertex 70 device (FIGS. 2 to 4).

The X-ray scattering curve (FIG. 2) demonstrates a high homogeneity in diameters of the hybrid imogolite nanotubes; it also makes it possible to determine the mean value of this diameter, which is between 3.3 and 3.4 nm.

The cryo-TEM image (FIG. 3) shows the tubular structure of the hybrid imogolite nanotubes and the absence of other nanoscale objects in the dialyzed sample. A mean length of the hybrid imogolite nanotubes of between 100 and 200 nm is measured.

Infrared spectroscopy (FIG. 4) confirms the chemical structure of the imogolite.

### Example 2

30 mL of a solution of aluminosilicate, the aluminum/silicon molar ratio of which was set at 2 and the hydrolysis ratio (sodium hydroxide/aluminum molar ratio) of which was also set at 2, were prepared as follows:
an aqueous aluminum solution is prepared by dissolving 0.487 g of aluminum perchlorate in pure water, in order to obtain a 0.1 mol.L⁻¹ solution, and is then transferred into a 10 mL volumetric flask,
a solution of 50 mL of 0.1 mol.L⁻¹ sodium hydroxide is prepared by dissolving 0.2 g of sodium hydroxide and is then transferred into a 20 mL volumetric flask.

The aluminum perchlorate solution is transferred into a Teflon container containing a magnetic bar and is then stirred. Methyltriethoxysilane (71.3 μL) is added to the solution. The sodium hydroxide solution is subsequently added at a flow rate of 4 mL.min⁻¹ using a peristaltic pump. Once the addition is complete, the Teflon container is closed and left stirring at ambient temperature for a period of time of 20 h, and then placed in an oven at 85° C. for 5 days. The solution is subsequently washed and filtered several times in pure water using a 30 kDa membrane.

The yield of the synthesis after washing is greater than 50%.

In order to be able to analyze the hybrid imogolite nanotubes thus prepared, the latter were lyophilized in the solid form. A white powder, of very low density and volatile, is obtained.

The tubular structure of the hybrid imogolite nanotubes was demonstrated by SAXS (Small-Angle X-ray Scattering), cryo-TEM (cryogenic Transmission Electron Microscopy) and IR (infrared) spectroscopy (FIGS. 5 to 7).

As for example 1:
the X-ray scattering curve (FIG. 5) demonstrates a high homogeneity in diameters of the hybrid imogolite nanotubes; it also makes it possible to determine the mean value of this diameter, which is between 3.3 and 3.4 nm;
the cryo-TEM image (FIG. 6) shows the tubular structure of the hybrid imogolite nanotubes and the absence of other nanoscale objects in the dialyzed sample. These images make it possible to measure a length of the hybrid imogolite nanotubes of between 100 and 200 nm;
infrared spectroscopy (FIG. 7) confirms the chemical structure of the imogolite.

1. A process for the manufacture of hybrid imogolite nanotubes, comprising the following stages:
(i) dissolving a precursor of aluminum into an aqueous solution,
(ii) with stirring, adding to the aluminum solution obtained during stage (i) at least one silicon alkoxide, the silicon of which carries both hydrolyzable substituents and at least one nonhydrolyzable substituent, wherein the Al/Si molar ratio is between 1 and 4,
(iii) with stirring, adding a base to the aluminosilicate solution obtained during stage (ii), until a hydrolysis ratio of between 1 and 3 is obtained,
(iv) maintaining the stirring for a period of time of at least 15 hours, (v) heating the solution obtained during stage (iv) at a temperature of between 50 and 150° C., for a period of time between 2 and 8 days.

2. The process of claim 1, in which wherein the precursor of aluminum is chosen from aluminum perchlorate Al(ClO₄)₃, aluminum nitrate Al(NO₃)₃ or aluminum chloride AlCl₃.

3. The process of claim 1 wherein the aluminum concentration of the aqueous solution obtained during stage (i) is between 0.01 and 1 mol. l⁻¹.

4. The process of claim 1, wherein the silicon alkoxide corresponds to the formula X—Si(OR)₃, wherein R is a linear or branched C₁-C₆ alkyl or alkenyl group or a phenyl group, and X is a linear or branched C₁-C₁₂ alkyl group.

5. The process of claim 4, wherein R represents a methyl or ethyl group.

6. The process of claim 1, wherein the silicon alkoxide is chosen from methyltriethoxysilane (OC₂H₅)₃SiCH₃, methyltrimethoxysilane (OCH₃)₃SiCH₃ or phenyltriethoxysilane (OC₂H₅)₃SiC₆H₅.

7. The process of claim 1, wherein the Al/Si molar ratio during stage (ii) is between 1.5 and 2.5.

8. The process of claim 1, wherein the base added during stage (iii) is chosen from sodium hydroxide, potassium hydroxide or lithium hydroxide.

9. The process claim 1, wherein the addition of the base during stage (iii) is carried out at a flow rate of between 1 and 10 mL. min⁻¹.

10. The process of claim 1, wherein the hydrolysis ratio during stage (iii) is between 1.5 and 2.5.

11. The process of claim 1, wherein the heating stage (v) is carried out at a temperature of between 70 and 150° C.

12. The process as of claim 1, wherein the heating stage (v) is carried out for a period of time of between 4 and 6 days.

13. The process of claim 1, further comprising a stage (vi) of washing or concentrating the solution obtained during stage (v).

14. The process of claim 1, further comprising a lyophilization stage (vii).

15. A hybrid imogolite nanotube obtained according to the process of claim 1, it simultaneously comprising a hydrophilic surface and a hydrophobic surface, and exhibiting an external diameter ranging from 3.3 to 3.4 nm.

16. The hybrid imogolite nanotube of claim 15, wherein the length is from 100 to 200 nm.

17. The process of claim 11, wherein the heating stage (v) is carried out at a temperature of between 80 and 90° C.
